(19) United States
(12) Patent Application Publication
(10) Pub. No.: US 2012/0247269 A1
(43) Pub. Date: Oct. 4, 2012

(54) DRIVE DEVICE FOR ELECTRIC VEHICLE

(75) Inventor: Ryuta HORIE, Anjo (JP)

(73) Assignee: AISIN AW CO., LTD., ANJO-SHI (JP)

(21) Appl. No.: 13/368,967

(22) Filed: Feb. 8, 2012

(30) Foreign Application Priority Data
Mar. 31, 2011 (JP) 2011-078516

(51) Int. Cl. F16H 37/06

(52) U.S. Cl. 74/665 L

(57) ABSTRACT

A drive device for an electric vehicle, which includes an output member drivingly coupled to a wheel, and a compressor coupling member coupled to a compressor for an air conditioner. The drive device includes a first rotating electrical machine having a rotor shaft drivingly coupled to the output member; a second rotating electrical machine having a rotor shaft drivingly coupled to the compressor coupling member and drivingly coupled to the output member; a first engagement device capable of disconnecting the drive coupling between the rotor shaft of the first rotating electrical machine and the output member; and a second engagement device capable of disconnecting the drive coupling between the rotor shaft of the second rotating electrical machine and the output member.

### INCORPORATION BY REFERENCE

The disclosure of Japanese Patent Application No. 2011-078516 filed on Mar. 31, 2011 including the specification, drawings and abstract is incorporated herein by reference in its entirety.

### BACKGROUND OF THE INVENTION

The present invention relates to a drive device for an electric vehicle, which includes an output member drivingly coupled to wheels, and a compressor coupling member coupled to a compressor for an air conditioner, and which generates, by a rotating electrical machine, a driving force to be transmitted to the output member and the compressor coupling member.

### DESCRIPTION OF THE RELATED ART

Regarding such a vehicle drive control device as described above, Japanese Patent Application Publication No. JP-A-2010-178403 below, for example, describes the following technique. In the technique of JP-A-2010-178403, a rotor shaft of a rotating electrical machine for an air conditioner is drivingly coupled not only to a compressor coupling member but also to an output member, so that a driving force of the rotating electrical machine for the air conditioner can be used to assist a rotating electrical machine for driving the wheels, thereby driving a vehicle.

In the technique of JP-A-2010-178403, however, a rotor shaft of the rotating electrical machine for driving the wheels is drivingly coupled to a ring gear of a planetary gear unit, the rotor shaft of the rotating electrical machine for the air conditioner and the compressor coupling member are drivingly coupled to a sun gear of the planetary gear unit, and the output member is drivingly coupled to a carrier of the planetary gear unit. Thus, the rotor shaft of the rotating electrical machine for driving the wheels, the rotor shaft of the rotating electrical machine for the air conditioner, and the output member are always drivingly coupled together via the planetary gear unit. That is, the technique of JP-A-2010-178403 is configured so that a change in rotational speed of the rotating electrical machines and the output member affects each other.

Accordingly, in the technique of JP-A-2010-178403, the practical ranges of the rotational speed of each rotating electrical machine and the output member need be considered when setting the usable range of the rotating speed of each rotating electrical machine. Thus, a rotating electrical machine having a usable range of the rotating speed which is optimal for driving the vehicle and the compressor cannot necessarily be used as the rotating electrical machine for driving the wheels or the rotating electrical machine for the air conditioner.

### SUMMARY OF THE INVENTION

Thus, in the case where a drive device for an electric vehicle includes two rotating electrical machines, and is configured so that the rotating electrical machine for driving an air conditioner is used to drive wheels as well, a drive device for an electric vehicle is desired which is capable of setting, for each of the two rotating electrical machines, a usable range of the rotating speed which is optimal for driving the wheels.

According to a first aspect of the present invention, a drive device for an electric vehicle includes an output member drivingly coupled to a wheel, and a compressor coupling member coupled to a compressor for an air conditioner, and generates, by a rotating electrical machine, a driving force to be transmitted to the output member and the compressor coupling member. The drive device includes: a first rotating electrical machine having a rotor shaft drivingly coupled to the output member; a second rotating electrical machine having a rotor shaft drivingly coupled to the compressor coupling member and drivingly coupled to the output member; a first engagement device capable of disconnecting the drive coupling between the rotor shaft of the first rotating electrical machine and the output member; and a second engagement device capable of disconnecting the drive coupling between the rotor shaft of the second rotating electrical machine and the output member.

Note that in the present application, the “rotating electrical machine” is used as a concept including all of a motor (an electric motor), a generator (an electric generator), and a motor-generator that functions both as the motor and the generator as necessary.

In the present application, the expression “drivingly coupled” refers to the state in which two rotating elements are coupled together so as to be able to transmit a driving force therebetween, and is used as a concept including the state in which the two rotating elements are coupled together so as to rotate together, or the state in which the two rotating elements are coupled together so as to be able to transmit the driving force therebetween via one or more transmission members. Such transmission members include various members that transmit rotation at the same speed or at a shifted speed, and include, e.g., a shaft, a gear mechanism, a belt, a chain, etc. Such transmission members may include an engagement element that selectively transmits rotation and a driving force, such as a friction clutch, a meshing clutch etc.

According to the first aspect, the drive coupling between the rotor shaft of the first rotating electrical machine and the output member can be disconnected by the first engagement device. Thus, by controlling the first engagement device to a disengaged state before the rotational speed of the first rotating electrical machine exceeds its maximum rotational speed, the first rotating electrical machine can be made not to rotate at a rotational speed higher than the maximum rotational speed. Accordingly, since the drive device includes the first engagement device, the maximum rotational speed of the first rotating electrical machine in conversion to the rotational speed at the output member can be set regardless of a practical range of the rotational speed of the output member, whereby flexibility in setting the maximum rotational speed of the first rotating electrical machine in conversion to the rotational speed at the output member can be increased.

Moreover, in the case of causing the first rotating electrical machine not to output the torque for driving the wheels, the first engagement device can be controlled to a disengaged state so that the first rotating electrical machine does not rotate. This can reduce energy loss caused by rotating the first rotating electrical machine.

According to the first aspect, the drive coupling between the rotor shaft of the second rotating electrical machine and the output member can be disconnected by the second engagement device. Thus, in the case of causing the second rotating electrical machine not to output the torque for driving the wheels, the second engagement device can be controlled to a disengaged state so that the second rotating electrical machine does not rotate. This can reduce energy loss caused by rotating the second rotating electrical machine. Moreover, in the case of causing the second rotating electrical machine to output only the torque for driving the compressor, the second engagement device is controlled to a disengaged state, whereby the second rotating electrical machine can be operated at an optimal rotational speed and with optimal output torque for driving the compressor. Thus, energy efficiency can be enhanced, and optimal air conditioning can be performed.

According to a second aspect of the present invention, the driving force to be transmitted to the output member and the compressor coupling member may be generated only by the first rotating electrical machine and the second rotating electrical machine.

According to the second aspect, the driving forces of the first rotating electrical machine and the second rotating electrical machine can be effectively used in the drive device for an electronic vehicle which uses the rotating electrical machine as a driving force source of the vehicle and the compressor.

According to a third aspect of the present invention, a maximum output that is set for the second rotating electrical machine may be larger than a maximum output that is set for the first rotating electrical machine.

According to the third aspect, a high efficiency region of the first rotating electrical machine can be shifted to a lower output side with respect to a high efficiency region of the second rotating electrical machine. Thus, the high efficiency region of the first rotating electrical machine can be easily shifted toward a high frequency region in steady running so as to overlap this high frequency region. This can increase the frequency at which the high efficiency region of the first rotating electrical machine is used during actual running of the vehicle, and can improve the power consumption rate.

According to a fourth aspect of the present invention, an output converted maximum rotational speed of the second rotating electrical machine that is obtained by converting a maximum value of a rotational speed, at which the second rotating electrical machine can transmit torque to the output member, to a rotational speed at the output member may be equal to or higher than a rotational speed of the output member at a maximum vehicle speed.

According to the fourth aspect, the second rotating electrical machine can individually output the torque at the maximum vehicle speed, and driving performance of the vehicle can be ensured. Thus, the first rotating electrical machine can be made not to transmit the torque to the wheels at around the maximum vehicle speed, whereby the flexibility in setting the maximum rotational speed of the first rotating electrical machine in conversion to the rotational speed of the output member can be easily increased.

According to a fifth aspect of the present invention, an output converted maximum rotational speed of the first rotating electrical machine that is obtained by converting a maximum value of a rotational speed, at which the first rotating electrical machine can transmit torque to the output member, to a rotational speed at the output member may be lower than that of the second rotating electrical machine.

According to the fifth aspect, the output converted maximum rotational speed of the first rotating electrical machine is set to a relatively low value. Thus, the high efficiency region of the first rotating electrical machine can be set in a lower rotational speed region in conversion to the rotational speed at the output member. Accordingly, the high efficiency region of the first rotating electrical machine can be easily shifted toward the high frequency region in the steady running so as to overlap this high frequency region. This can increase the frequency at which the high efficiency region of the first rotating electrical machine is used during actual running of the vehicle, and can improve the power consumption rate.

According to a sixth aspect of the present invention, output converted maximum torque of the second rotating electrical machine, which is a maximum value of torque the second rotating electrical machine can transmit to the output member, may be higher than that of the first rotating electrical machine, and the output converted maximum torque of the second rotating electrical machine may be set so that the output converted maximum torque of the second rotating electrical machine is equal to or larger than maximum vehicle required torque that is required to be transmitted to the output member to drive the wheel, individually or in combination with the output converted maximum torque of the first rotating electrical machine.

According to the sixth aspect, the second rotating electrical machine can output the torque corresponding to the maximum vehicle required torque, individually or in combination with the first rotating electrical machine, whereby driving performance of the vehicle can be ensured.

According to a seventh aspect of the present invention, the first engagement device may disconnect the drive coupling between the rotor shaft of the first rotating electrical machine and the output member at a predetermined vehicle speed or higher.

According to the seventh aspect, the drive coupling between the drive coupling between the rotor shaft of the first rotating electrical machine and the output member is disconnected by the first engagement device at the predetermined vehicle speed or higher. Thus, the first rotating electrical machine can be made not to rotate at the predetermined vehicle speed or higher. Since the first rotating electrical machine need not be rotated at a high rotational speed equal to or higher than the rotational speed corresponding to the predetermined vehicle speed or higher, the maximum rotational speed of the first rotating electrical machine can be set regardless of the practical range of the vehicle speed.

According to an eighth aspect of the present invention, the drive device for an electric vehicle may further include a third engagement device capable of disconnecting the drive coupling between the rotor shaft of the second rotating electrical machine and the compressor coupling member.

According to the eighth aspect, in the case where there is no request to drive the compressor, the third engagement device is controlled to a disengaged state. This can prevent consumption of driving energy caused by transmission of the torque of the second rotating electrical machine to the compressor.

Regardless of whether there is a request to drive the compressor or not, in the case where the vehicle required torque that is required to be transmitted to the wheels is high, etc., the third engagement device is controlled to the disengaged state so that the driving force of each rotating electrical machine is transmitted to the output member without being transmitted to the compressor. Thus, driving performance of the vehicle can be preferentially ensured.

### BRIEF DESCRIPTION OF THE DRAWINGS

FIG. 1 is a skeleton diagram of a drive device for electric vehicles according to an embodiment of the present invention;

FIG. 2 is a block diagram showing the configuration of a control device according to the embodiment of the present invention;

FIGS. 3A and 3B show diagrams illustrating output torque characteristics of the drive device for electric vehicles according to the embodiment of the present invention;

FIG. 4 is a diagram illustrating control of engagement devices and rotating electrical machines of the drive device for electric vehicles according to the embodiment of the present invention;

FIG. 5 is a diagram illustrating output torque characteristics of a drive device for electric vehicles according to another embodiment;

FIG. 6 is a diagram illustrating control of engagement devices and rotating electrical machines of the drive device for electric vehicles according to the other embodiment;

FIG. 7 is a skeleton diagram of a drive device for electric vehicles according to still another embodiment;

FIG. 8 is a diagram illustrating control of engagement devices and rotating electrical machines of the drive device for electric vehicles according to the other embodiment;

FIG. 9 is a skeleton diagram of a drive device for electric vehicles according to still another embodiment;

FIG. 10 is a skeleton diagram of a drive device for electric vehicles according to still another embodiment; and

FIG. 11 is a diagram illustrating control of engagement devices and rotating electrical machines of the drive device for electric vehicles according to the other embodiments.

### DETAILED DESCRIPTION OF THE EMBODIMENTS

### First Embodiment

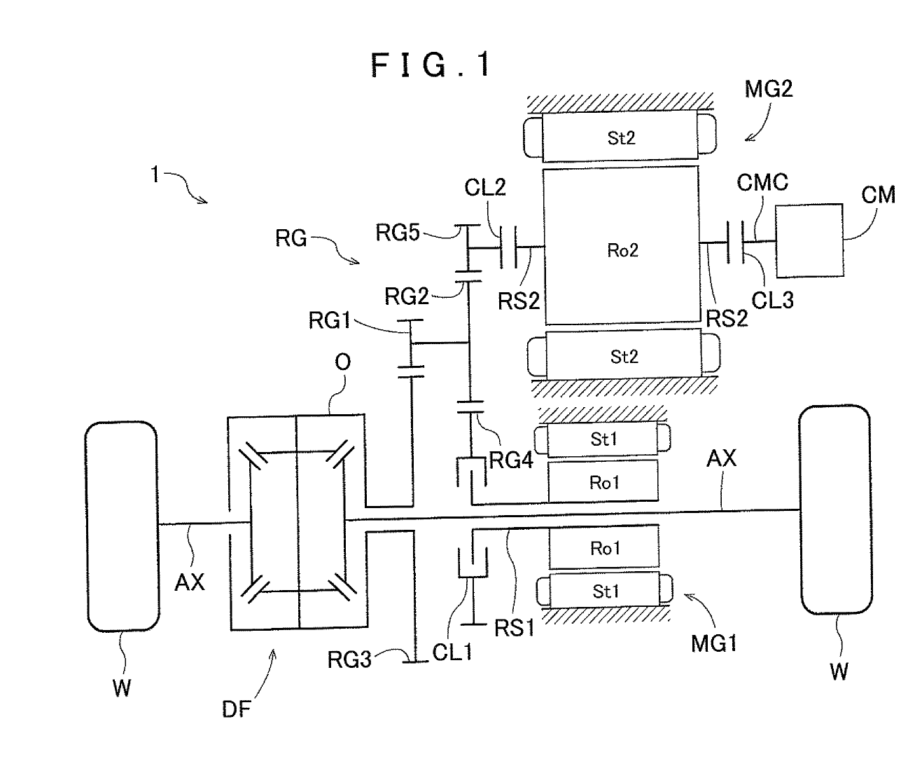

An embodiment of a drive device 1 for electric vehicles according to the present invention will be described with reference to the accompanying drawings. FIG. 1 is a schematic diagram showing a schematic configuration of the drive device 1 for electric vehicles according to the present embodiment. As shown in the drawing, the drive device 1 for electric vehicles according to the present embodiment is a drive device that has an output shaft O drivingly coupled to wheels W, and a compressor coupling shaft CMC coupled to a compressor CM for an air conditioner, and that generates, by rotating electrical machines MG1, MG2, a driving force to be transmitted to the output shaft O and the compressor coupling shaft CMC.

The drive device 1 for electric vehicles includes the first rotating electrical machine MG1 having a rotor shaft RS1 drivingly coupled to the output shaft O. The drive device 1 for electric vehicles further includes the second rotating electrical machine MG2 having a rotor shaft RS2 drivingly coupled to the compressor coupling shaft CMC and drivingly coupled to the output shaft O. Note that the output shaft O corresponds to the “output member” in the present invention, and the compressor coupling shaft CMC corresponds to the “compressor coupling member” in the present application.

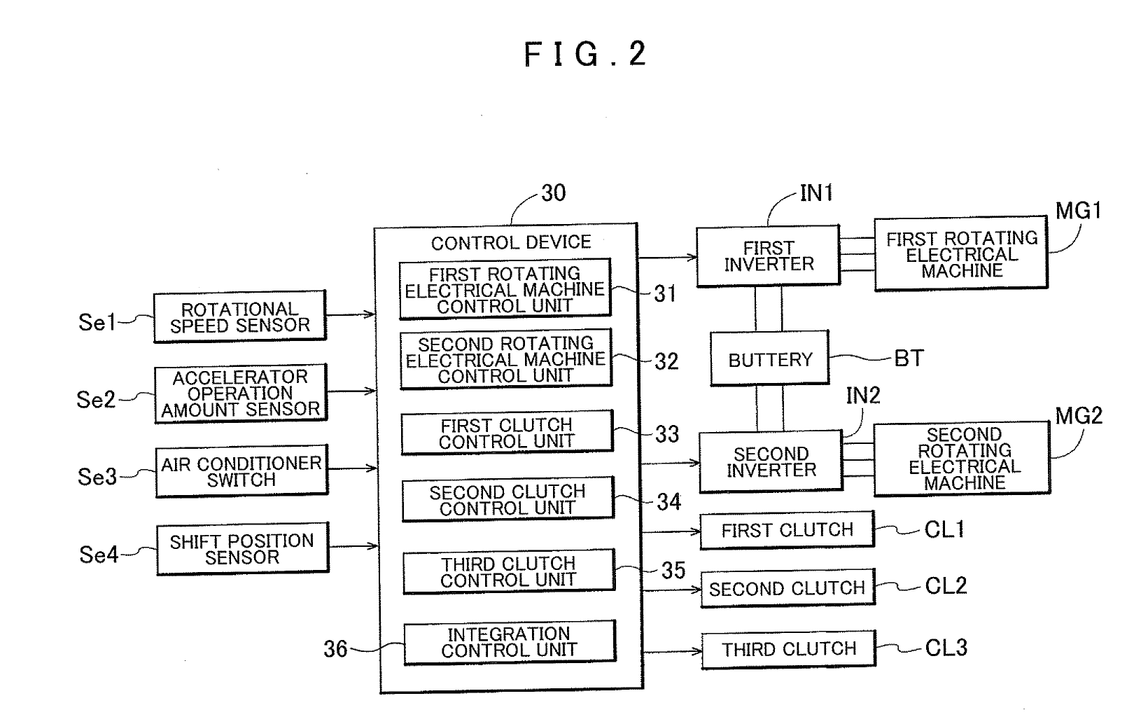

In such a configuration, the drive device 1 for electric vehicles includes a first clutch CL1 capable of disconnecting the drive coupling between the rotor shaft RS1 of the first rotating electrical machine and the output shaft O, and a second clutch CL2 capable of disconnecting the drive coupling between the rotor shaft RS2 of the second rotating electrical machine and the output shaft O. Note that in the present embodiment, the drive device 1 for electric vehicles further includes a third clutch CL3 capable of disconnecting the drive coupling between the rotor shaft RS2 of the second rotating electrical machine and the compressor coupling shaft CMC. As shown in FIG. 2, the drive device 1 for electric vehicles further includes a control device 30 that controls the first clutch CL1, the second clutch CL2, the third clutch CL3, the first rotating electrical machine MG1, and the second rotating electrical machine MG2. The first clutch CL1 corresponds to the “first engagement device” in the present invention, the second clutch CL2 corresponds to the “second engagement device” in the present invention, and the third clutch CL3 corresponds to the “third engagement device” in the present invention. The drive device 1 for electric vehicles according to the present embodiment will be explained in detail below.

1. Configuration of Drive Device 1 for Electric Vehicles

1-1. First Rotating Electrical Machine MG1

As shown in FIG. 1, the first rotating electrical machine MG1 has a stator St1 fixed to a non-rotating member, and a rotor Ro1 that is disposed radially inside the stator St1 and has the rotor shaft RS1 that is rotatably supported. The rotor shaft RS1 of the first rotating electrical machine is drivingly coupled to the output shaft O so that rotation of the rotor shaft RS1 is transmitted via a power transmission mechanism RG and transmitted to the output shaft O.

The first rotating electrical machine MG1 is electrically connected to a battery BT as an electricity storage device via a first inverter IN1 that performs direct current-alternating current (DC-AC) conversion (see FIG. 2). The first rotating electrical machine MG1 is capable of functioning both as a motor (an electric motor) that is supplied with electric power to generate motive power, and as a generator (an electric generator) that is supplied with motive power to generate electric power. That is, the first rotating electrical machine MG1 is supplied with electric power from the battery BT via the first inverter IN1 to perform power running, or stores (charges) electric power, which is generated by a rotation driving force transmitted from the wheels W, in the battery BT via the first inverter IN1. Note that the buttery BT is an example of the electricity storage device, and it is also possible to use other electricity storage device such as a capacitor, or to use a plurality of types of electricity storage devices. The first inverter IN1 includes a plurality of switching elements for converting DC power of the battery BT into AC power to drive the first rotating electrical machine MG1, or for converting AC power generated by the first rotating electrical machine MG1 into DC power to charge the buttery BT.

In the present embodiment, the rotor shaft RS1 of the first rotating electrical machine is drivingly coupled to the output shaft O via the first clutch CL1 and the power transmission mechanism RG. The output shaft O is drivingly coupled to two axles AX, namely right and left axles AX, via an output differential gear unit DF, and the axles AX are drivingly coupled to the two wheels W, namely the right and left wheels W, respectively. Thus, when the first clutch CL1 is in an engaged state, the torque transmitted from the first rotating electrical machine MG1 to the rotor shaft RS1 is transmitted to the right and left wheels W via the power transmission mechanism RG, the output shaft O, the output differential gear unit DF, and the axles AX. Note that instead of or in addition to the power transmission mechanism RG, a speed change mechanism, such as a transmission device configured to be able to change the speed ratio and a planetary gear mechanism, may be provided on the power transmission path from the first rotating electrical machine MG1 to the wheels W.

The rotor shaft RS1 of the first rotating electrical machine is configured to be drivingly coupled to the compressor coupling shaft CMC via the first clutch CL1, the power transmission mechanism RG, the second clutch CL2, the rotor shaft RS2 of the second rotating electrical machine, and the third clutch CL3. Thus, when the first clutch CL1, the second clutch CL2, and the third clutch CL3 are in an engaged state, the torque transmitted from the first rotating electrical machine MG1 to the rotor shaft RS1 is transmitted also to the compressor coupling shaft CMC.

1-2. First Clutch CL1

The first clutch CL1 is an engagement device that selectively drivingly couples the rotor shaft RS1 of the first rotating electrical machine to the output shaft O or disconnects (separates) the drive coupling therebetween. In the present embodiment, an input-side member of the first clutch CL1 is drivingly coupled to the rotor shaft RS1 of the first rotating electrical machine so as to rotate together with the rotor shaft RS1, and an output-side member of the first clutch CL1 is drivingly coupled to a fourth gear RG4 of the power transmission mechanism RG so as to rotate together with the fourth gear RG4. The input-side and output-side members of the first clutch CL1 are selectively engaged with or disengaged from each other. In the present embodiment, the first clutch CL1 is an electromagnetic clutch. The “electromagnetic clutch” is a device that is engaged or disengaged by an electromagnetic force that is generated by an electromagnet. Note that a hydraulic clutch that is engaged or disengaged by an oil pressure, an electric clutch that is engaged or disengaged by a driving force of a servomotor, etc. may be used as the first clutch CL1.

1-3. Second Rotating Electrical Machine MG2

The second rotating electrical machine MG2 has a stator St2 fixed to a non-rotating member, and a rotor Ro2 that is disposed radially inside the stator St2 and has the rotor shaft RS2 rotatably supported. The rotor shaft RS2 of the second rotating electrical machine is drivingly coupled to the compressor coupling shaft CMC via the third clutch CL3. The rotor shaft RS2 of the second rotating electrical machine is also drivingly coupled to the output shaft O via the second clutch CL2 and the power transmission mechanism RG.

The second rotating electrical machine MG2 is electrically connected to the battery BT as the electricity storage device via a second inverter IN2 that performs DC-AC conversion (see FIG. 2). The second rotating electrical machine MG2 is capable of functioning both as a motor (an electric motor) that is supplied with electric power to generate motive power, and as a generator (an electric generator) that is supplied with motive power to generate electric power. That is, the second rotating electrical machine MG2 is supplied with electric power from the battery BT via the second inverter IN2 to perform power running, or stores (charges) electric power, which is generated by a rotation driving force transmitted from the wheels W, in the battery BT via the second inverter IN2. The second inverter IN2 includes a plurality of switching elements for converting DC power of the battery BT into AC power to drive the second rotating electrical machine MG2, or for converting AC power generated by the second rotating electrical machine MG2 into DC power to charge the buttery BT.

When the third clutch CL3 is in an engaged state, the torque transmitted from the second rotating electrical machine MG2 to the rotor shaft RS2 is transmitted to the compressor coupling shaft CMC.

When the second clutch CL2 is in an engaged state, the torque transmitted from the second rotating electrical machine MG2 to the rotor shaft RS2 is transmitted to the right and left wheels W via the power transmission mechanism RG the output shaft O, the output differential gear unit DF, and the axles AX. Note that instead of or in addition to the power transmission mechanism RG, a speed change mechanism, such as a transmission device configured to be able to change the speed ratio and a planetary gear mechanism, may be provided on the power transmission path from the second rotating electrical machine MG2 to the wheels W.

1-4. Second Clutch CL2

The second clutch CL2 is an engagement device that selectively drivingly couples the rotor shaft RS2 of the second rotating electrical machine to the output shaft O or disconnects (separates) the drive coupling therebetween. In the present embodiment, an input-side member of the second clutch CL2 is drivingly coupled to the rotor shaft RS2 of the second rotating electrical machine so as to rotate together with the rotor shaft RS2, and an output-side member of the second clutch CL2 is drivingly coupled to a fifth gear RG5 of the power transmission mechanism RG so as to rotate together with the fifth gear RG5. The input-side and output-side members of the second clutch CL2 are selectively engaged with or disengaged from each other. In the present embodiment, the second clutch CL2 is an electromagnetic clutch. Note that a hydraulic clutch, an electric clutch, etc. may be used as the second clutch CL2.

1-5. Third Clutch CL3

The third clutch CL3 is an engagement device that selectively drivingly couples the rotor shaft RS2 of the second rotating electrical machine to the compressor coupling shaft CMC or disconnects (separates) the drive coupling therebetween. In the present embodiment, an input-side member of the third clutch CL3 is drivingly coupled to the rotor shaft RS2 of the second rotating electrical machine so as to rotate together with the rotor shaft RS2, and an output-side member of the third clutch CL3 is drivingly coupled to the compressor coupling shaft CMC so as to rotate together with the compressor coupling shaft CMC. The input-side and output-side members of the third clutch CL3 are selectively engaged with or disengaged from each other. In the present embodiment, the third clutch CL3 is an electromagnetic clutch. Note that a hydraulic clutch, an electric clutch, etc. may be used as the third clutch CL3.

1-6. Power Transmission Mechanism RG

As described above, in the present embodiment, the output-side member of the first clutch CL1 and the output-side member of the second clutch CL2 are configured to be drivingly coupled to the output shaft O via the power transmission mechanism RG. As shown in FIG. 1, the power transmission mechanism RG includes a counter gear mechanism formed by a first gear RG1 and a second gear RG2, a third gear RG3, the fourth gear RG4, and the fifth gear RG5. The counter gear mechanism is configured so that the first gear RG1 and the second gear RG2 having a larger diameter than the first gear RG1 are drivingly coupled together so as to rotate together. The first gear RG1 meshes with the third gear RG3 that is drivingly coupled to the output shaft O so as to rotate together with the output shaft O. The second gear RG2 meshes with the fourth gear RG4 that is drivingly coupled to the output-side member of the first clutch CL1 so as to rotate together with the output-side member of the first clutch CL1. The second gear RG2 also meshes, at a different circumferential position from the fourth gear RG4, with the fifth gear RG5 that is drivingly coupled to the output-side member of the second clutch CL2 so as to rotate together with the output-side member of the second clutch CL2.

The power transmission mechanism RG reduces the rotational speed of the rotor shaft RS1 of the first rotating electrical machine at a predetermined speed ratio (deceleration ratio) to transmit the reduced rotational speed to the output shaft O, and reduces the rotational speed of the rotor shaft RS2 of the second rotating electrical machine at a predetermined speed ratio to transmit the reduced rotational speed to the output shaft O. Thus, in the present embodiment, the power transmission mechanism RG functions as a reduction gear for both the first rotating electrical machine MG1 and the second rotating electrical machine MG2. Note that in the illustrated example, the speed ratio from the rotor shaft RS1 of the first rotating electrical machine to the output shaft O is set to a smaller value than the speed ratio from the rotor shaft RS2 of the second rotating electrical machine to the output shaft O. As used herein, the “speed ratio” refers to a ratio of the rotational speed of the rotor shaft RS1 of the first rotating electrical machine or the rotor shaft RS2 of the second rotating electrical machine to the rotational speed of the output shaft O, and in the present application, is a value obtained by dividing the rotational speed of each of the rotor shafts RS1, RS2 by the rotational speed of the output shaft O.

1-7. Output Differential Gear Unit DF

The output differential gear unit DF is a differential gear mechanism that uses a plurality of bevel gears meshing each other, and is configured to distribute the rotation and torque that are transmitted to the output shaft O, and to transmit the distributed rotation and torque to the right and left wheels W via the axles AX, respectively.

1-8. Compressor CM

A vehicle is provided with an air conditioner for adjusting the temperature and humidity in the vehicle. The compressor CM is a device that compresses a heat medium used for the air conditioner, and is driven by a rotation driving force applied from the outside. In the present embodiment, a vane rotary compressor is used as the compressor CM. A rotor of the compressor CM is drivingly coupled to the compressor coupling shaft CMC so as to rotate together with the compressor coupling shaft CMC. Note that a scroll compressor, a swash plate compressor, a variable displacement (single-sided swash plate) compressor, etc. may be used as the compressor CM.

In the present embodiment, the compressor coupling shaft CMC is configured to be drivingly coupled to the rotor shaft RS2 of the second rotating electrical machine via the third clutch CL3. Thus, when the third clutch CL3 is in an engaged state, rotation of the rotor shaft RS2 of the second rotating electrical machine can be transmitted to the rotor of the compressor CM to rotationally drive the compressor CM.

2. Output Torque Characteristics of Vehicle

Output torque characteristics required for the vehicle, output torque characteristics that are set for the first rotating electrical machine MG1 and the second rotating electrical machine MG2, and functions of each clutch will be described below.

2-1. Drive Device for Electric Vehicles in Comparative Example

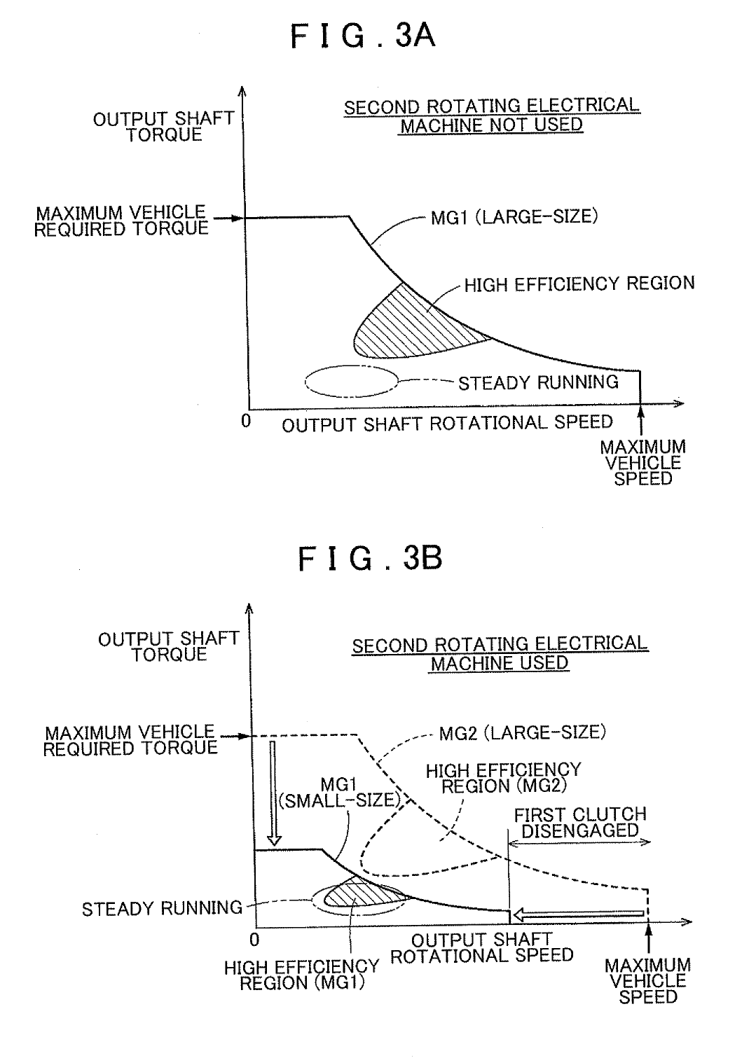

Unlike the present embodiment, a drive device for electric vehicles in a comparative example, which does not use the second rotating electrical machine MG2 as a driving force source of the vehicle, need be configured to provide sufficient output torque characteristics of the vehicle from the driving force of only the first rotating electrical machine, as shown in FIG. 3A. That is, as shown in the comparative example of FIG. 3A, the first rotating electrical machine need be able to output required torque in the practical range of the rotational speed of the output shaft O corresponding to the maximum vehicle speed. In particular, the first rotating electrical machine is required to output such torque that allows the vehicle to climb up a slope having a predetermined steep gradient (e.g., 18°). Thus, as shown in the comparative example of FIG. 3A, the first rotating electrical machine need be able to output the torque corresponding to the maximum vehicle required torque that is the maximum value of such vehicle required torque that is required to be transmitted to the output shaft O in order to drive the wheels in such cases. That is, the output converted maximum torque, which is the maximum value of the torque the first rotating electrical machine can transmit to the output shaft O, need be equal to or larger than the maximum vehicle required torque.

Moreover, the first rotating electrical machine is required to output the torque up to the maximum vehicle speed (e.g., 120 km/h) required for the vehicle. Thus, the first rotating electrical machine need be able to output the torque at up to the rotational speed corresponding to this maximum vehicle speed. That is, the output converted maximum rotational speed, which is a value obtained by converting the maximum value of the rotational speed, at which the first rotating electrical machine MG1 can transmit the torque, to the output shaft O to the rotational speed at the output shaft O, need be equal to or higher than the rotational speed of the output shaft O at the maximum vehicle speed.

Accordingly, unlike the present embodiment, the drive device for electric vehicles which does not use the second rotating electrical machine MG2 needs to have, as the first rotating electrical machine MG1, a large, high-performance rotating electrical machine having large maximum output torque and capable of outputting torque up to a high maximum rotational speed.

As shown by a hatched region in FIGS. 3A and 3B, a high efficiency region having high conversion efficiency from electric power to torque is present in an intermediate rotational speed region and an intermediate output torque region in the operating region of the rotating electrical machine. On the other hand, as shown by two-dot chain line in FIGS. 3A and 3B, a high frequency region in steady running (e.g., 50 to 60 km/h) on local roads is present in a low to intermediate rotational speed region and a low output torque region in the practical range of the vehicle. However, unlike the present embodiment, in the first rotating electrical machine in the drive device for electric vehicles which does not use the second rotating electrical machine MG2, the high efficiency region does not match the high frequency region in the steady running. Thus, the high frequency region of the first rotating electrical machine is less frequently used, making it difficult to improve the power consumption rate.

2-2. Drive Device for Electric Vehicles in Embodiment

2-2-1. Use of Second Rotating Electrical Machine as Driving Force Source of Vehicle

On the other hand, the drive device 1 for electric vehicles according to the present embodiment is configured so that not only the rotor shaft RS1 of the first rotating electrical machine but also the rotor shaft RS2 of the second rotating electrical machine are drivingly coupled to the output shaft O so as to be used for the driving force source of the vehicle. Thus, the first rotating electrical machine MG1 and the second rotating electrical machine MG2 need only be configured so that the first rotating electrical machine MG1 and the second rotating electrical machine MG2 are capable of outputting the vehicle required torque in the practical range of the rotating speed of the output shaft O and capable of outputting the maximum vehicle required torque, individually or in combination. That is, the first rotating electrical machine MG1 and the second rotating electrical machine MG2 need only be configured so that the output torque of either one of the first and second rotating electrical machines MG1, MG2 or the total output torque of both the first and second rotating electrical machines MG1, MG2, in conversion to the torque on the output shaft O, satisfies the vehicle required torque in the practical range of the rotational speed of the output shaft O.

Accordingly, as compared to the drive device for electric vehicles in the comparative example which does not use the second rotating electrical machine MG2 as the driving force source of the vehicle, the flexibility in setting the output torque characteristics for the first rotating electrical machine MG1 can be increased in the present embodiment.

<Reduction of Output Converted Maximum Torque of First Rotating Electrical Machine>

In the present embodiment, as shown in FIG. 3B, the first rotating electrical machine MG1 is configured so that the output converted maximum torque, which is the maximum value of the torque the first rotating electrical machine MG1 can transmit to the output shaft O, is lower than the maximum vehicle required torque.

The high efficiency region of the rotating electrical machine is similarly located in the inter mediate torque region with respect to the maximum output torque of the rotating electrical machine and in the intermediate rotational speed region with respect to the maximum rotational speed at which the rotating electrical machine can output the torque, regardless of the size of the rotating electrical machine, etc. Thus, the high efficiency region of the rotating electrical machine is located in the intermediate torque region with respect to the output converted maximum output torque of the rotating electrical machine, and in the intermediate rotational speed region with respect to the output converted maximum rotational speed of the rotating electrical machine.

In the present embodiment, the output converted maximum torque of the first rotating electrical machine MG1 is set to be lower than the maximum vehicle required torque. Thus, the high efficiency region of the first rotating electrical machine MG1, which is located in the intermediate torque region of the output converted maximum torque, is shifted down from the intermediate torque region with respect to the maximum vehicle required torque toward the high frequency region in the steady running, which is located in the low torque region with respect to the maximum vehicle required torque, so as to overlap the high frequency region in the steady running. This can increase the frequency at which the high efficiency region of the first rotating electrical machine MG1 is used, and can improve the power consumption rate.

2-2-2. Disconnection of First Rotating Electrical Machine MG1 by First Clutch CL1

When the rotating electrical machine rotates at a rotational speed exceeding the maximum rotational speed at which the rotational electrical machine can output torque, a counter electromotive voltage generated by the rotation may increase and exceed its tolerance. Thus, the rotational electrical machine need be configured so as not to rotate at a rotational speed higher than the maximum rotational speed at which the rotational electrical machine can output torque. Accordingly, in the above comparative example of FIG. 3A, the first rotating electrical machine is configured so that the output converted maximum rotational speed, which is obtained by converting the maximum rotational speed, at which the first rotating electrical machine MG1 can output torque, to the rotational speed at the output shaft O, is equal to or higher than the rotational speed of the output shaft O at the maximum vehicle speed.

On the other hand, the drive device 1 for electric vehicles according to the present embodiment includes the first clutch CL1 capable of disconnecting the drive coupling between the rotor shaft RS1 of the first rotating electrical machine and the output shaft O. Thus, when the rotational speed of the output shaft O exceeds the output converted maximum rotational speed of the first rotating electrical machine MG1, the first clutch CL1 can be disengaged so that the first rotating electrical machine MG1 does not rotate at a rotational speed higher than the maximum rotational speed. Accordingly, in the present embodiment, the output converted maximum rotational speed of the first rotating electrical machine MG1 can be set regardless of the rotational speed of the output shaft O at the maximum vehicle speed, whereby the flexibility of setting can be increased.

<Reduction of Output Converted Maximum Rotational Speed of First Rotating Electrical Machine>

In the present embodiment, as shown in FIG. 3B, the output converted maximum rotational speed of the first rotating electrical machine MG1, which is a value obtained by converting the maximum value of the rotational speed, at which the first rotating electrical machine MG1 can transmit torque to the output shaft O, to the rotational speed at the output shaft O, is made lower than the rotational speed of the output shaft O at the maximum vehicle speed.

Accordingly, the high efficiency region of the first rotating electrical machine MG1 located in the intermediate rotational speed region with respect to the output converted maximum rotational speed of the first rotating electrical machine MG1 can be set to be lower than the intermediate rotational speed region with respect to the rotational speed of the output shaft O at the maximum vehicle speed. Thus, the high efficiency region of the first rotating electrical machine MG1 is shifted toward the high frequency region in the steady running located in the low to intermediate rotational speed region with respect to the rotational speed of the output shaft O at the maximum vehicle speed, so as to overlap this high frequency region in the steady running. This can increase the frequency at which the high efficiency region of the first rotating electrical machine MG1 is used, and can improve the power consumption rate.

Note that the high efficiency region of the first rotating electrical machine MG1 may be set in any operating region according to required performance of the vehicle. For example, the high efficiency region of the first rotating electrical machine MG1 may be shifted toward a high frequency region in acceleration running so as to overlap this high frequency region.

As described above, in the present embodiment, the output converted maximum torque and the output converted maximum rotational speed of the first rotating electrical machine MG1 are set to be lower than the maximum vehicle required torque and the rotational speed of the output shaft O at the maximum vehicle speed, respectively. Thus, the high efficiency region of the first rotating electrical machine MG1 can be shifted toward the high frequency region in the steady running in the actual running of the vehicle, so as to overlap this high frequency region.

In other words, in the present embodiment, the output converted maximum torque and the output converted maximum rotational speed of the first rotating electrical machine MG1 are set so as to increase the amount by which the high efficiency region of the first rotating electrical machine MG1 overlaps the high frequency region in the steady running.

2-2-3. Output Torque Characteristics of Second Rotating Electrical Machine MG2

On the other hand, as shown in FIG. 3B, in the second rotating electrical machine MG2 according to the present embodiment, its output converted maximum torque, which is the maximum value of the torque the second rotating electrical machine MG2 can transmit to the output shaft O, is set to be higher than that of the first rotating electrical machine MG1, and is set to be individually equal to or larger than the maximum vehicle required torque. Thus, the second rotating electrical machine MG2 can individually output the torque corresponding to the maximum vehicle required torque.

In the second rotating electrical machine MG2 of the present embodiment, the output converted maximum rotational speed, which is a value obtained by converting the maximum value of the rotational speed, at which the second rotating electrical machine MG2 can transmit the torque to the output shaft O to the rotational speed at the output shaft O, are set to be equal to or higher than the rotational speed of the output shaft O at the maximum vehicle speed. Thus, the second rotating electrical machine MG2 can individually output the torque at the maximum vehicle speed. Accordingly, the output converted maximum rotational speed of the first rotating electrical machine MG1 is set to be lower than that of the second rotating electrical machine MG2.

As described above, in the present embodiment, the output converted maximum torque and the output converted maximum rotational speed of the second rotating electrical machine MG2 are set to be equal to or larger than the maximum vehicle required torque and the rotational speed of the output shaft O at the maximum vehicle speed, respectively. Thus, the maximum torque required for the vehicle and the torque output at the maximum vehicle speed can be satisfied by the second rotating electrical machine MG2, and driving performance can be ensured.

2-2-4. Disconnection of Second Rotating Electrical Machine MG2 by Second Clutch CL2

The drive device 1 for electric vehicles according to the present embodiment includes the second clutch CL2 capable of disconnecting the drive coupling between the rotor shaft RS2 of the second rotating electrical machine MG2 and the output shaft O.

The second clutch CL2 is disengaged in the case of causing the second rotating electrical machine MG2 not to output the torque for driving the vehicle. This can disconnect the drive coupling between the rotor shaft RS2 of the second rotating electrical machine and the output shaft O so that the second rotating electrical machine MG2 does not rotate. This can reduce energy loss caused by rotating the second rotating electrical machine MG2, and can improve the driving efficiency of the vehicle by the first rotating electrical machine MG1.

The second clutch CL2 is also disengaged in the case of causing the second rotating electrical machine MG2 to output the torque in order to merely drive the compressor CM. This allows the second rotating electrical machine MG2 to be operated at an optimal rotational speed and with optimal output torque for driving the compressor CM, without being affected by the rotational speed of the output shaft O, whereby the energy efficiency can be enhanced, and optimal air conditioning can be performed.

2-2-5. Maximum Output of Rotating Electrical Machine

In the present embodiment, the maximum output that is set for the second rotating electrical machine MG2 is higher than the maximum output that is set for the first rotating electrical machine MG1. As used herein, the “output of the rotating electrical machine” refers to power [W]. That is, the output of the rotating electrical machine corresponds to the output torque multiplied by the rotating speed. In the output torque characteristics shown in FIG. 3B, the output converted maximum torque of the maximum output that is set for each rotating electrical machine MG1, MG2 is generally located on a curve (a maximum output curve) that changes in inverse proportion to the rotational speed of the output shaft O. The maximum output curve of the second rotating electrical machine MG2 is located outside (on the upper right side of) the maximum output curve of the first rotating electrical machine MG1, and the maximum output that is set for the second rotating electrical machine MG2 is higher than the maximum output that is set for the first rotating electrical machine MG1.

As used herein, the “maximum output that is set for each rotating electrical machine MG1, MG2” is the maximum value of the output of each rotating electrical machine MG1, MG2 in conversion to the output on the output shaft O, under the conditions in which each rotating electrical machine MG1, MG2 is mounted on the vehicle and is controlled by the control device 30. That is, the “maximum output that is set for each rotating electrical machine MG1, MG2” is the maximum output in the output torque characteristics of each rotating electrical machine MG1, MG2 that are set in the control device 30, as shown in FIG. 3B.

2-2-6. Disconnection of Compressor CM by Third Clutch CL3

The drive device 1 for electric vehicles according to the present embodiment includes the third clutch CL3 capable of disconnecting the drive coupling between the rotor RS2 of the second rotating electrical machine MG2 and the compressor coupling shaft CMC.

As described above, the second rotating electrical machine MG2 is used not only as a driving force source of the compressor CM but also as a driving force source of the vehicle. When the second rotating electrical machine MG2 is used as the driving force source of the vehicle, the rotational speed of the second rotating electrical machine MG2 changes to a high rotational speed corresponding to the maximum vehicle speed in proportion to the vehicle speed regardless of a request to drive the compressor CM. In the present embodiment, since no speed change mechanism capable of changing the speed ratio is provided between the second rotating electrical machine and the output shaft O, the maximum rotational speed of the second rotating electrical machine MG2 is relatively high. The driving energy for the compressor CM increases according to the rotational speed of the compressor CM. Thus, if the compressor CM is rotated at up to the high rotational speed corresponding to the maximum vehicle speed, loss of energy for driving the compressor CM is increased. Moreover, a high-performance compressor capable of rotating at up to the high rotational speed corresponding to the maximum vehicle speed need be used as the compressor CM.

However, the third clutch CL3 is provided in the present embodiment. Thus, when there is no request to drive the compressor CM, the third clutch CL3 is disengaged, which can prevent excessive consumption of the driving energy due to the compressor CM being driven according to the vehicle speed.

Since the third clutch CL3 is disengaged regardless of whether a request to drive the compressor is present or not, the driving forces of the second rotating electrical machine MG2 and the first rotating electrical machine MG1 can be transmitted to the output shaft O without being transmitted to the compressor CM, and can be preferentially used to drive the vehicle. Moreover, disengaging the third clutch CL3 can cause the compressor CM not to rotate at up to the high rotational speed corresponding to the maximum vehicle speed. This eliminates the need to use a high-performance compressor capable of rotating at up to the high rotational speed as the compressor CM, and allows a relatively inexpensive compressor to be used.

3. Configuration of Control Device 30

The configuration of the control device 30 will be described below with reference to FIG. 2. The control device 30 controls the first clutch CL1, the second clutch CL2, the third clutch CL3, the first rotating electrical machine MG1, and the second rotating electrical machine MG2.

The control device 30 is configured to include as a core member an arithmetic processing unit such as a central processing unit (CPU), and to include a storage device such as a random access memory (RAM) configured to be able to read and write data from the arithmetic processing unit, a read only memory (ROM) configured to be able to read data from the arithmetic processing unit, etc. One or both of software (a program) stored in the ROM etc. of the control device 30 and separately provided hardware such as an arithmetic circuit form function units 31 to 36 of the control device 30 as shown in FIG. 2.

As shown in FIG. 2, the drive device 1 for electric vehicles includes sensors Se1 to Se4, and an electrical signal that is output from each sensor is input to the control device 30. The control device 30 calculates detection information of each sensor based on the input electrical signal.

The rotational speed sensor Se1 is a sensor that detects the rotational speed of the output shaft O. Since the rotational speed of the output shaft O is proportional to the vehicle speed, the control device 30 calculates the vehicle speed based on the input signal from the rotational speed sensor Se1.

The accelerator operation amount sensor Se2 is a sensor that detects the accelerator operation amount representing the amount by which an accelerator pedal is operated by the driver.

The air conditioner switch Se3 is a switch that is operated by the driver to control the operating state of the air conditioner. Information on the switch position of the air conditioner switch Se3 is input to the control device 30.

The shift position sensor Se4 is a sensor that detects the selected position (the shift position) of a shift lever. The control device 30 detects which range has been designated by the driver, such as a “drive range,” a “neutral range,” a “rearward drive range,” or a “parking range,” based on the input information from the shift position sensor Se4.

As shown in FIG. 2, the control device 30 includes function units such as the first rotating electrical machine control unit 31, the second rotating electrical machine control unit 32, the first clutch control unit 33, the second clutch control unit 34, the third clutch control unit 35, and the integration control unit 36. Each function unit will be described in detail below.

3-1. First Rotating Electrical Machine Control Unit 31

The first rotating electrical machine control unit 31 is a function unit that controls the operation of the first rotating electrical machine MG1.

The first rotating electrical machine control unit 31 performs control to cause the first rotating electrical machine MG1 to output first required torque received from the integration control unit 36 described later. Thus, the first rotating electrical machine control unit 31 performs drive control of the first inverter 1N1 by outputting a signal that drives turning on/off of the plurality of switching elements included in the first inverter IN1, based on the first required torque, the rotation angle of the first rotating electrical machine MG1, the coil current, etc.

3-2. Second Rotating Electrical Machine Control Unit 32

The second rotating electrical machine control unit 32 is a function unit that controls the operation of the second rotating electrical machine MG2.

The second rotating electrical machine control unit 32 performs control to cause the second rotating electrical machine MG2 to output second required torque received from the integration control unit 36 described later. Thus, the second rotating electrical machine control unit 32 performs drive control of the second inverter IN2 by outputting a signal that drives turning on/off of the plurality of switching elements included in the second inverter IN2, based on the second required torque, the rotation angle of the second rotating electrical machine MG2, the coil current, etc.

3-3. First Clutch Control Unit 33

The first clutch control unit 33 is a function unit that controls operation of the first clutch CL1.

The first clutch control unit 33 controls engagement or disengagement of the first clutch CL1 by outputting a signal that causes engagement or disengagement of the first clutch CL1, according to a command to engage or disengage the first clutch CL1, which is received from the integration control unit 36 described later. In the present embodiment, the first clutch control unit 33 is configured to output a signal that switches on/off application of a current to a coil of an electromagnet provided in the first clutch CL1.

3-4. Second Clutch Control Unit 34

The second clutch control unit 34 is a function unit that controls operation of the second clutch CL2.

The second clutch control unit 34 controls engagement or disengagement of the second clutch CL2 by outputting a signal that causes engagement or disengagement of the second clutch CL2, according to a command to engage or disengage the second clutch CL2, which is received from the integration control unit 36 described later. In the present embodiment, the second clutch control unit 34 is configured to output a signal that switches on/off application of a current to a coil of an electromagnet provided in the second clutch CL2.

3-5. Third Clutch Control Unit 35

The third clutch control unit 35 is a function unit that controls operation of the third clutch CL3.

The third clutch control unit 35 controls engagement or disengagement of the third clutch CL3 by outputting a signal that causes engagement or disengagement of the third clutch CL3, according to a command to engage or disengage the third clutch CL3, which is received from the integration control unit 36 described later. In the present embodiment, the third clutch control unit 35 is configured to output a signal that switches on/off application of a current to a coil of an electromagnet provided in the third clutch CL3

3-6. Integration Control Unit 36

The integration control unit 36 is a function unit that performs control to integrate, in the entire vehicle, torque control that is performed on the first clutch CL1, the second clutch CL2, the third clutch CL3, the first rotating electrical machine MG1, the second rotating electrical machine MG2, etc., engagement control of the clutches, etc.

The integration control unit 36 calculates the vehicle required torque, which is a target driving force to be transmitted from the driving force source to the output shaft O, according to the accelerator operation amount, the vehicle speed (the rotational speed of the output shaft O), the charging amount of the battery, etc. The integration control unit 36 calculates the first required torque and the second required torque, which are output torques that the rotating electrical machines MG1, MG2, respectively, are required to output, and determines the commands to engage or disengage the first clutch CL1, the second clutch CL2, and the third clutch CL3, based on the vehicle speed (the rotational speed of the output shaft O), the vehicle required torque, etc., and sends the first required torque, the second required torque, and the commands to the other function units 31 to 35 to perform integration control.

3-6-1. Control of Clutches and Rotating Electrical Machines

In order to output the torque adapted to the above output torque characteristics of the vehicle to the output shaft O, the integration control unit 36 determines the commands to engage or disengage the first clutch CL1, the second clutch CL2, and the third clutch CL3, and determines the driving state of each rotating electrical machine MG1, MG2, and sends a command to each function unit 31 to 35.

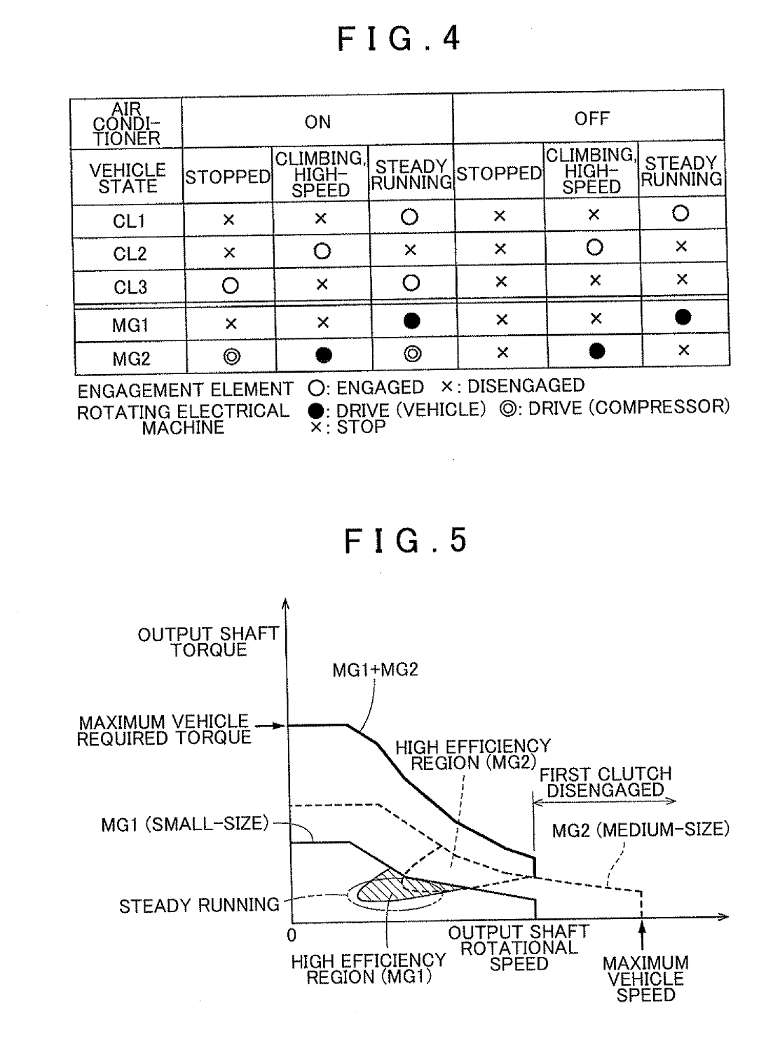

In the present embodiment, as shown in FIG. 4, the integration control unit 36 determines the commands to engage or disengage the clutches CL1 to CL3, and determines the driving state of each rotating electrical machine MG1, MG2, according to whether a request to operate the air conditioner is present or not and according to the running state of the vehicle.

In the present embodiment, at a predetermined vehicle speed or more, the integration control unit 36 controls the first clutch CL1 to a disengaged state to disconnect the drive coupling between the rotor shaft RS1 of the first rotating electrical machine and the output shaft O. Control of the clutches and the rotating electrical machines by the integration control unit 36 will be in detail below.

The integration control unit 36 determines the running state of the vehicle, according to the vehicle required torque calculated based on the accelerator operation amount, the vehicle speed, etc. as described above, and the rotational speed (the vehicle speed) of the output shaft O.

If the rotational speed of the output shaft O and the vehicle required torque are zero, the integration control unit 36 determines the running state of the vehicle as the “stopped” state.

If it is determined that the vehicle required torque is equal to or higher than a predetermined torque threshold, the integration control unit 36 determines that the vehicle is climbing up a slope or is accelerated, and thus determines the running state of the vehicle as the “climbing” state. For example, the torque threshold is set to the output converted maximum torque of the first rotating electrical machine MG1 at the rotational speed of the output shaft O.

If it is determined that the rotational speed (the vehicle speed) of the output shaft O is equal to or higher than a predetermined speed threshold, the integration control unit 36 determines the running state of the vehicle as the “high-speed running” state. For example, the speed threshold is set to the output converted maximum rotational speed of the first rotating electrical machine MG1.

Thus, if it is determined that the vehicle required torque and the rotational speed of the output shaft O are located outside the torque output region of the first rotating electrical machine MG1, which is shown as the region surrounded by solid line in FIG. 3B, the integration control unit 36 determines the running state of the vehicle as the “climbing” state or the “high-speed running” state.

If the running state of the vehicle is determined as none of the “stopped” state, the “climbing” state, and the “high-speed running” state, the integration control unit 36 determines the running state of the vehicle as the “steady running” state.

If it is determined based on the position of the air conditioner switch that operation of the air conditioner, which requires driving of the compressor CM, is requested by the driver, the integration control unit 36 determines that there is a request to operate the air conditioner. Otherwise, the integration control unit 36 determines that there is no request to operate the air conditioner. In FIG. 4, “ON” means that there is a request to operate the air conditioner, and “OFF” means that there is no request to operate the air conditioner.

3-6-1-1. In the Case where there is Request to Operate Air Conditioner

In the case where there is a request to operate the air conditioner, and the running state of the vehicle is the “stopped” state, the integration control unit 36 controls the third clutch CL3 to an engaged state and controls the second clutch CL2 to a disengaged state to drivingly couple the rotor shaft RS2 of the second rotating electrical machine only to the compressor coupling shaft CMC, so that the driving force of the second rotating electrical machine MG2 can be transmitted only to the compressor CM. The integration control unit 36 calculates the second required torque, based on the torque (compressor required torque) required to drive the compressor. Note that in this case, the integration control unit 36 controls the first clutch CL1 to a disengaged state to disconnect the rotor shaft RS1 of the first rotating electrical machine from the output shaft O, and stops driving of the first rotating electrical machine MG1.

In the case where there is a request to operate the air conditioner, and the running state of the vehicle is the “steady running” state (in the case where the vehicle required torque can be output only by the first rotating electrical machine MG1) as well, the integration control unit 36 controls the third clutch CL3 to an engaged state and controls the second clutch CL2 to a disengaged state to drivingly couple the rotor shaft RS2 of the second rotating electrical machine only to the compressor coupling shaft CMC, so that the driving force of the second rotating electrical machine MG2 can be transmitted only to the compressor CM. The integration control unit 36 calculates the second required torque based on the compressor required torque.

In the case where the running state of the vehicle is the “steady running” state, the integration control unit 36 controls the first clutch CL1 to an engaged state to drivingly couple the rotor shaft RS1 of the first rotating electrical machine to the output shaft O, so that the driving force of the first rotating electrical machine MG1 can be transmitted to the output shaft O. The integration control unit 36 calculates the first required torque based on the vehicle required torque.

On the other hand, in the case where there is a request to operate the air conditioner, but the running state of the vehicle is the “climbing” state or the “high-speed running” state (in the case where the vehicle required torque cannot be output only by the first rotating electrical machine MG1), the integration control unit 36 controls the second clutch CL2 to an engaged state and controls the third clutch CL3 to a disengaged state to drivingly couple the rotor shaft RS2 of the second rotating electrical machine only to the output shaft O, so that the driving force of the second rotating electrical machine MG2 can be transmitted only to the output shaft O. Moreover, the integration control unit 36 controls the first clutch CL1 to a disengaged state to disconnect the rotor shaft RS1 of the first rotating electrical machine from the output shaft O. The integration control unit 36 calculates the second required torque based on the vehicle required torque, and stops driving of the first rotating electrical machine MG1, so that the vehicle is driven by the second rotating electrical machine MG2.

With this configuration, in the case where there is a request to operate the air conditioner, but the vehicle required torque cannot be output only by the first rotating electrical machine MG1, driving of the compressor CM is stopped, and the driving force of the second rotating electrical machine MG2 is used only to drive the vehicle, whereby the driving performance of the vehicle can be preferentially ensured.

Moreover, in the case where there is a request to operate the air conditioner, but the running state of the vehicle is the “high-speed running” state, and the compressor coupling shaft CMC is rotated at the high rotational speed, the third clutch CL3 is controlled to a disengaged state to stop driving of the compressor CM, whereby the compressor CM can be made not to rotate at up to the high rotational speed. This eliminates the need to use a high-performance compressor capable of rotating at up to the high rotational speed as the compressor CM, and allows a relatively inexpensive compressor to be used.

In the case where the running state of the vehicle is the “high-speed running” state, the first clutch CL1 is controlled to a disengaged state so that the first rotating electrical machine MG1 does not rotate at a rotational speed equal to or higher than the output converted maximum rotational speed. This allows the output converted maximum rotational speed of the first rotating electrical machine MG1 to be set regardless of the rotational speed of the output shaft O at the maximum vehicle speed. In the present embodiment, the output converted maximum rotational speed of the first rotating electrical machine MG1 is set to be lower than the rotational speed of the output shaft O at the maximum vehicle speed. This can increase the frequency at which the high efficiency region of the first rotating electrical machine MG1 is used, and can improve the power consumption rate.

3-6-1-2. In the Case where there is No Request to Operate Air Conditioner

In the case there is no request to operate the air conditioner, the integration control unit 36 controls the third clutch CL3 to a disengaged state regardless of the running state of the vehicle.

In the case where the running state of the vehicle is the “stopped” state, the integration control unit 36 controls not only the third clutch CL3 but also the first clutch CL1 and the second clutch CL2 to a disengaged state. The integration control unit 36 stops driving of each rotating electrical machine MG1, MG2.

In the case where the running state of the vehicle is the “steady running” state, the integration control unit 36 controls not only the third clutch CL3 but also the second clutch CL2 to a disengaged state to disconnect the rotor shaft RS2 of the second rotating electrical machine from the compressor coupling shaft CMC and the output shaft O. The integration control unit 36 stops driving of the second rotating electrical machine MG2. The integration control unit 36 also controls the first clutch CL1 to an engaged state to drivingly couple the rotor shaft RS1 of the first rotating electrical machine to the output shaft O, so that the driving force of the first rotating electrical machine MG1 can be transmitted to the output shaft O. The integration control unit 36 calculates the first required torque based on the vehicle required torque.

On the other hand, in the case where there is no request to operate the air conditioner, and the running state of the vehicle is the “climbing” state or the “high-speed running” state (in the case where the vehicle required torque cannot be output only by the first rotating electrical machine MG1), the integration control unit 36 controls the second clutch CL2 to an engaged state and controls the first clutch CL1 and the third clutch CL3 to a disengaged state, as in the case where there is a request to operate the air conditioner as described above. The integration control unit 36 calculates the second required torque based on the vehicle required torque, and stops driving of the first rotating electrical machine MG1.

Thus, as in the case where there is a request to operate the air conditioner as described above, in the case where there is no request to operate the air conditioner, but the vehicle required torque cannot be output only by the first rotating electrical machine MG1, the driving force of the second rotating electrical machine MG2 is used to drive the vehicle, and the vehicle required torque can be output.

### Other Embodiments

Lastly, other embodiments of the present invention will be described. Note that the configuration of each embodiment described below is not limited to the configuration that can be individually used, but may be used in combination with the configurations of other embodiments as long as no inconsistency arises.

(1) The above embodiment is described with respect to an example in which the output converted maximum torque of the second rotating electrical machine MG2 is set to be individually equal to or larger than the maximum vehicle required torque, as shown in FIG. 3B. However, embodiments of the present invention are not limited to this. That is, as shown in FIG. 5, the output converted maximum torque of the second rotating electrical machine MG2 may be set so that the sum of the output converted maximum torque of the second rotating electrical machine MG2 and the output converted maximum torque of the first rotating electrical machine MG1 is equal to or larger than the maximum vehicle required torque. Namely, the output converted maximum torque of the second rotating electrical machine MG2 may be set to be smaller than the maximum vehicle required torque and larger than the output converted maximum torque of the first rotating electrical machine MG1.

The output converted maximum torque of the second rotating electrical machine MG2 may be set to be smaller than the output converted maximum torque of the first rotating electrical machine MG1, if the sum of the output converted maximum torque of the second rotating electrical machine MG2 and the output converted maximum torque of the first rotating electrical machine MG1 is equal to or larger than the maximum vehicle required torque.

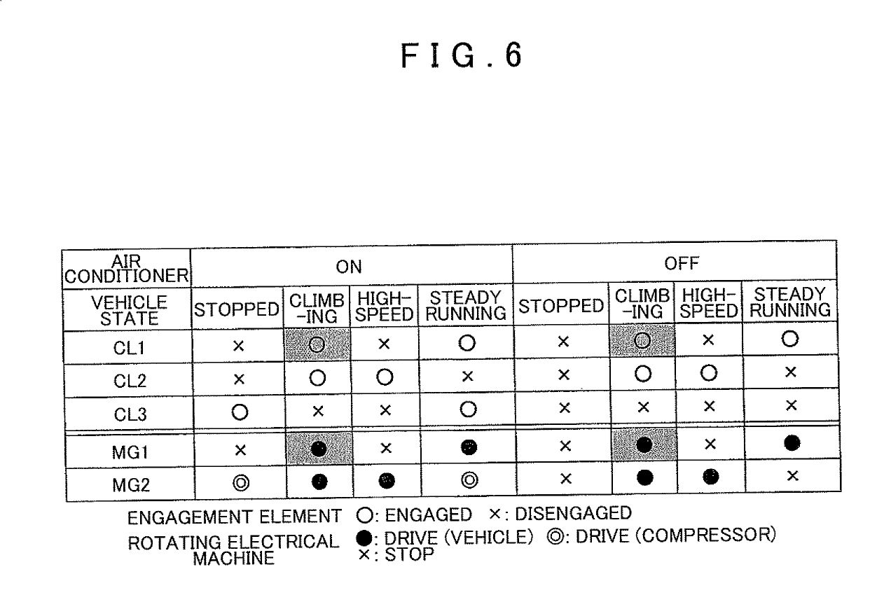

In this case, as shown in FIG. 6, in the case where the running state of the vehicle is the “climbing” state, the integration control unit 36 controls the first clutch CL1 to an engaged state regardless of whether there is a request to operate the air conditioner or not, and thus drivingly couples the rotor shaft RS1 of the first rotating electrical machine to the output shaft O, so that not only the driving force of the second rotating electrical machine MG2 but also the driving force of the first rotating electrical machine MG1 can be transmitted to the output shaft O. The integration control unit 36 calculates the first required torque and the second required torque based on the vehicle required torque. For example, the first required torque and the second required torque are set so that the sum of the first required torque and the second required torque, in conversion to the torque on the output shaft O, is equal to the vehicle required torque.

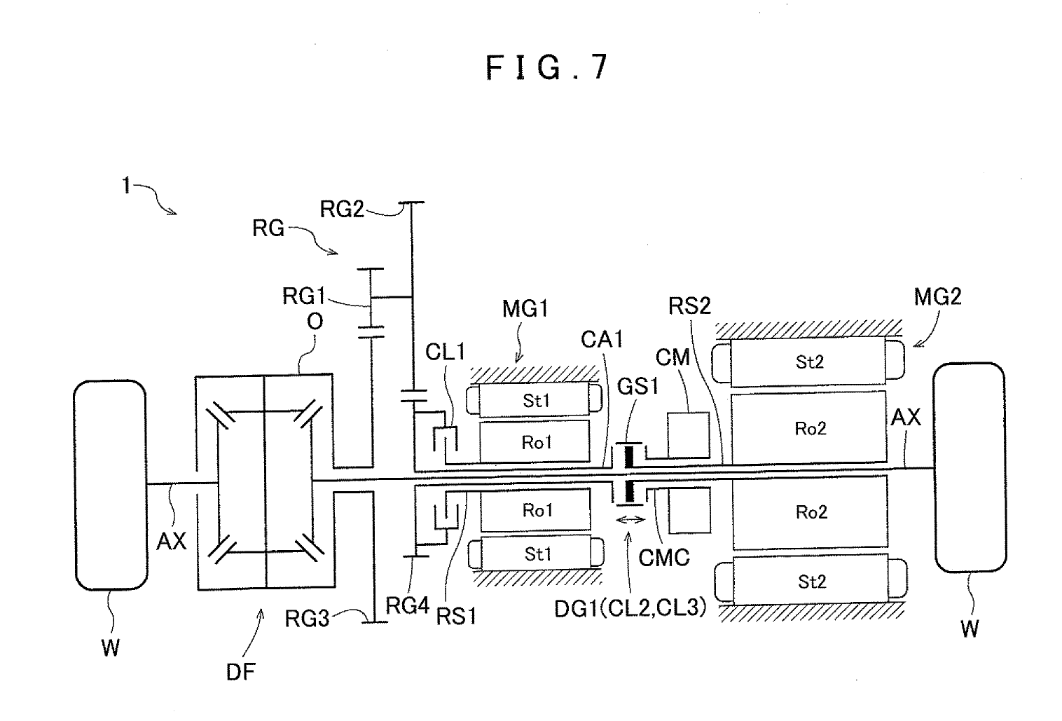

(2) The above embodiment is described with respect to an example in which the rotor shaft RS2 of the second rotating electrical machine is drivingly coupled to the output shaft O by engagement of the second clutch CL2, and is drivingly coupled to the compressor coupling shaft CMC by engagement of the third clutch CL3. However, embodiments of the present invention are not limited to this. That is, as shown in FIG. 7, the rotor shaft RS2 of the second rotating electrical machine MG2 may be configured to be selectively drivingly coupled to one of the output shaft O and the compressor coupling shaft CMC or disconnected from both of the output shaft O and the compressor coupling shaft CMC, by a dog clutch DG1.

For example, the dog clutch DG1 is spline-fitted on the rotor shaft RS2 of the second rotating electrical machine so as to be movable in the axial direction. In the case where a gear selector GS1 of the dog clutch DG1 is moved to the side of the output shaft O (the left side in FIG. 7) in the axial direction on the rotor shaft RS2, and is coupled to a coupling shaft CA1 drivingly coupled to the fourth gear RG4 of the power transmission mechanism RG, the fourth gear RG4 of the power transmission mechanism RG is drivingly coupled to the rotor shaft RS2 of the second rotating electrical machine MG2 via the dog clutch DG1, so that the driving force of the second rotating electrical machine MG2 can be transmitted only to the output shaft O.

On the other hand, in the case where the gear selector GS1 of the dog clutch DG1 is moved to the side of the compressor coupling shaft CMC (the right side in FIG. 7) in the axial direction on the rotor shaft RS2, and is coupled to the compressor coupling shaft CMC, the compressor coupling shaft CMC is drivingly coupled to the rotor shaft RS2 of the second rotating electrical machine MG2 via the dog clutch DG1, so that the driving force of the second rotating electrical machine MG2 can be transmitted only to the compressor coupling shaft CMC.

In the case where the gear selector GS1 of the dog clutch DG1 is located at an intermediate position between the coupling shaft CA1 and the compressor coupling shaft CMC, the dog clutch DG1 is in a disconnected state in which the rotor shaft RS2 of the second rotating electrical machine is drivingly coupled to any of the output shaft O and the compressor coupling shaft CMC.

Thus, the dog clutch DG1 functions as the second clutch CL2 that selectively drivingly couples the rotor shaft RS2 of the second rotating electrical machine to the output shaft O or disconnects the rotor shaft RS2 of the second rotating electrical machine from the output shaft O, and also functions as the third clutch CL3 that selectively drivingly couples the rotor shaft RS2 of the second rotating electrical machine to the compressor coupling shaft CMC or disconnects the rotor shaft RS2 of the second rotating electrical machine from the compressor coupling shaft CMC.

In the example shown in FIG. 7, the second rotating electrical machine MG2, the compressor CM, and the dog clutch DG1 are arranged coaxially with the first rotating electrical machine MG1. Note that the second rotating electrical machine MG2, the compressor CM, and the dog clutch DG1 may be arranged on a different axis from that of the first rotating electrical machine MG1, as shown in FIG. 1. In this case, the coupling shaft CA1 is drivingly coupled to the fifth gear R5 instead of the fourth gear RG4.

The dog clutch DG1 is configured to be moved in the axial direction by an electromagnetic force, a driving force of a servomotor, etc., and is controlled by the control device 30 by a method similar to that of the second clutch control unit 34 or the third clutch control unit 35.

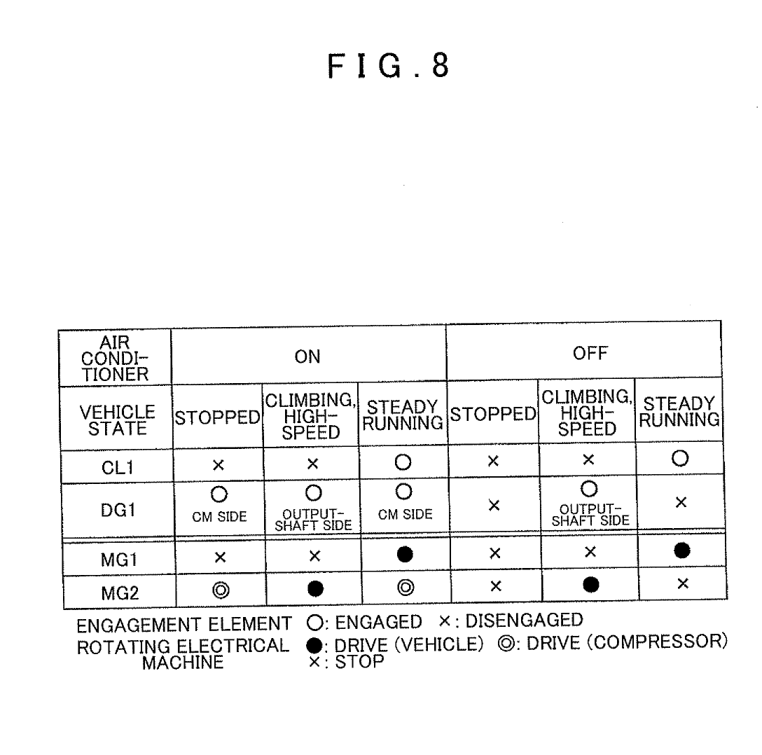

Specifically, as shown in FIG. 8, in the case where the running state of the vehicle is the “climbing” state or the “high-speed running” state, the integration control unit 36 controls the dog clutch DG1 to an engaged state with the output shaft O and thus drivingly couples the rotor shaft RS2 of the second rotating electrical machine to the output shaft O, so that the driving force of the second rotating electrical machine MG2 can be transmitted to the output shaft O, regardless of whether there is a request to operate the air conditioner or not.

In the case where there is a request to operate the air conditioner, and the running state of the vehicle is the “steady running” state or the “stopped” state, the integration control unit 36 controls the dog clutch DG1 to an engaged state with the compressor coupling shaft CMC to drivingly couple the rotor shaft RS2 of the second rotating electrical machine to the compressor coupling shaft CMC, so that the driving force of the second rotating electrical machine MG2 can be transmitted to the compressor coupling shaft CMC.

In the cases other than those described above, the integration control unit 36 controls the dog clutch DG1 to a disengaged state in which the dog clutch DG1 is not engaged with any of the output shaft O and the compressor coupling shaft CMC.

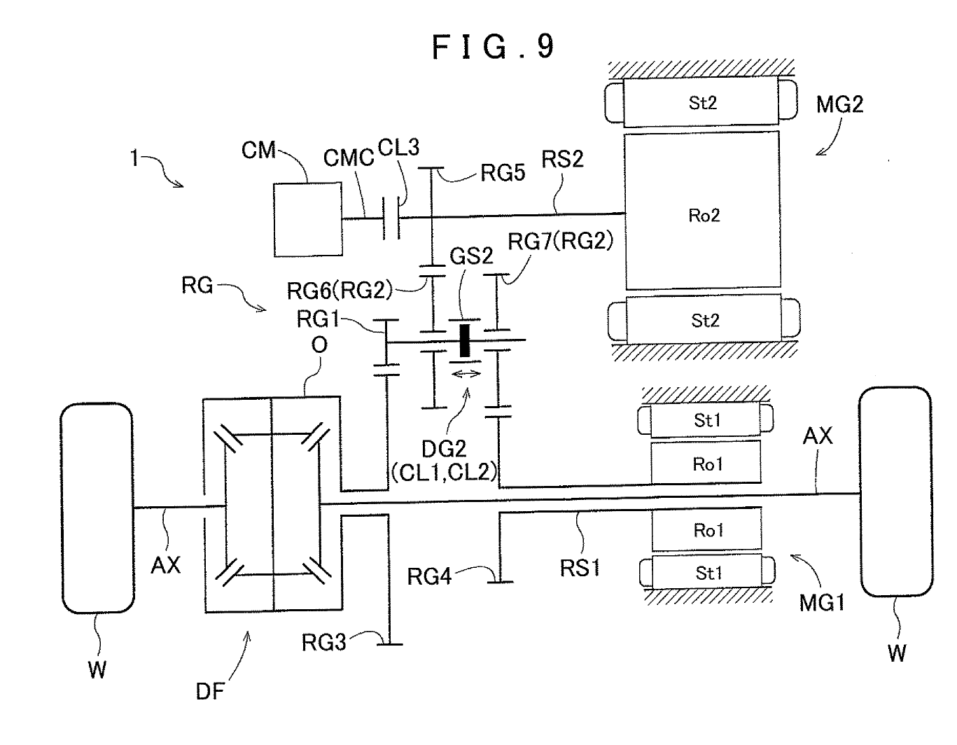

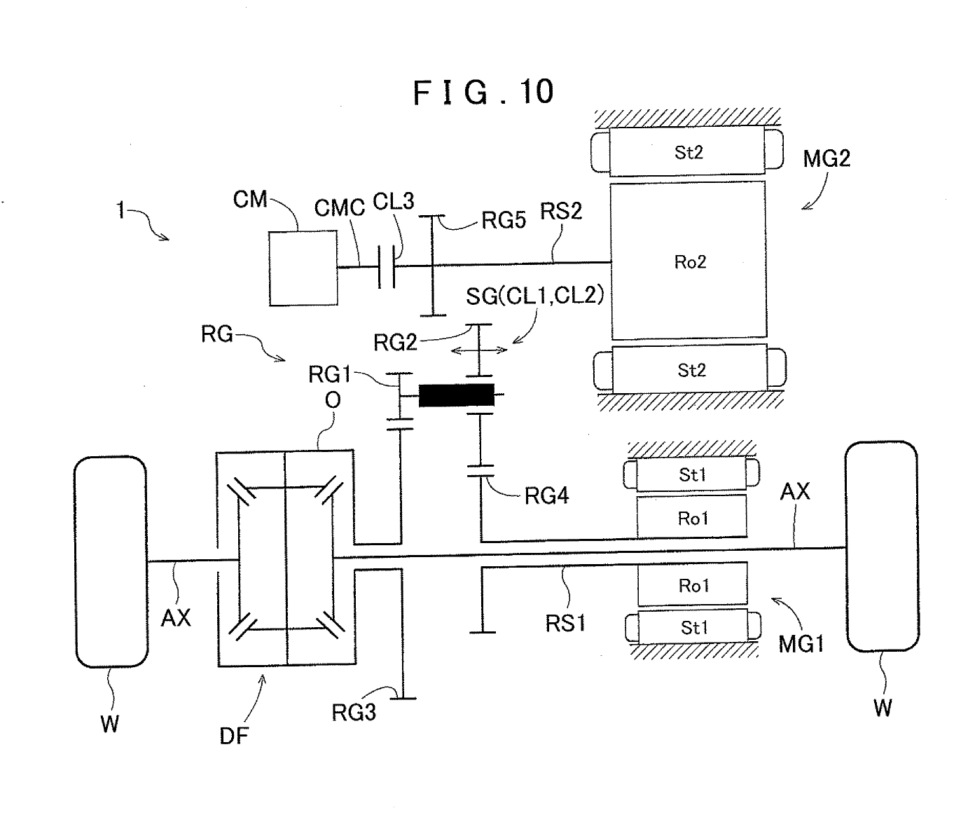

(3) The above embodiment is described with respect to an example in which the output shaft O is drivingly coupled to the rotor shaft RS1 of the first rotating electrical machine MG1 by engagement of the first clutch CL1, and is drivingly coupled to the rotor shaft RS2 of the second rotating electrical machine MG2 by engagement of the second clutch CL2. However, embodiments of the present invention are not limited to this. That is, as shown in FIG. 9 or 10, the output shaft O may be configured to be selectively drivingly coupled to one of the rotor shaft RS1 of the first rotating electrical machine and the rotor shaft RS2 of the second rotating electrical machine MG2, or disconnected from both the rotor shaft RS1 of the first rotating electrical machine and the rotor shaft RS2 of the second rotating electrical machine MG2, by a dog clutch DG2 or a slide gear SG.

<Dog Clutch DG2>

First, an example in which the dog clutch DG2 is provided will be described.

As shown in FIG. 9, for example, the power transmission mechanism RG includes, instead of the second gear RG2 of FIG. 1, a sixth gear RG6 rotatably supported around the axis of the first gear RG1, and a seventh gear RG7 similarly rotatably supported around the axis of the first gear RG1. The seventh gear RG7 meshes with the fourth gear RG4 that is drivingly coupled to the rotor shaft RS1 of the first rotating electrical machine so as to rotate together with the rotor shaft RS1. The sixth gear RG6 meshes with the fifth gear RG5 that is drivingly coupled to the rotor shaft RS2 of the second rotating electrical machine so as to rotate together with the rotor shaft RS2. The dog clutch DG2 is spline-fitted on the shaft of the first gear RG1 between the sixth gear RG6 and the seventh gear RG7 so as to be movable in the axial direction.

In the case where a gear selector GS2 of the dog clutch DG2 is moved to the side of the second rotating electrical machine (the left side in FIG. 9) in the axial direction on the shaft of the rotor shaft RS2, and is coupled to the sixth gear RG6, the first gear RG1 and the sixth gear RG6 of the power transmission mechanism RG are drivingly coupled together via the dog clutch DG2, so that the dog clutch DG2 is in an engaged state in which the rotor shaft RS2 of the second rotating electrical machine is drivingly coupled to the output shaft O.

On the other hand, in the case where the gear selector GS2 of the dog clutch DG2 is moved to the side of the first rotating electrical machine (the right side in FIG. 9) in the axial direction on the shaft of the first gear RG1, and is coupled to the seventh gear RG7, the first gear RG1 and the seventh gear RG7 of the power transmission mechanism RG are drivingly coupled together via the dog clutch DG2, so that the dog clutch DG2 is in an engaged state in which the rotor shaft RS1 of the first rotating electrical machine is drivingly coupled to the output shaft O.

In the case where the gear selector GS2 of the dog clutch DG2 is located at an intermediate position between the sixth gear RG6 and the seventh gear RG7, the dog clutch DG2 is in a disconnected state in which the output shaft O is not drivingly coupled to any of the rotor shaft RS1 of the first rotating electrical machine and the rotor shaft RS2 of the second rotating electrical machine.

Thus, the dog clutch DG2 functions as the first clutch CL1 that selectively drivingly couples the rotor shaft RS1 of the first rotating electrical machine to the output shaft O or disconnects the rotor shaft RS1 of the first rotating electrical machine from the output shaft O, and also functions as the second clutch CL2 that selectively drivingly couples the rotor shaft RS2 of the second rotating electrical machine to the output shaft O or disconnects the rotor shaft RS2 of the second rotating electrical machine from the output shaft O. Note that the dog clutch DC2 may be separately provided for coupling and disconnecting the sixth gear RG6 and for coupling and disconnecting the seventh gear RG7. In this case, both the first rotating electrical machine MG1 and the second rotating electrical machine MG2 can be coupled to the output shaft O to drive the vehicle by the two rotating electrical machines.

<Slide Gear SG>

An example in which the slide gear SG is provided will be described below. As shown in FIG. 10, for example, the second gear RG2 of the power transmission mechanism RG is spline-fitted on the shaft of the first gear RG1 so as to be movable in the axial direction, and forms the slide gear SG. The fifth gear RG5 that is drivingly coupled to the rotor shaft RS2 of the second rotating electrical machine and the fourth gear RG4 that is drivingly coupled to the rotor shaft RS1 of the first rotating electrical machine are arranged at a predetermined interval therebetween in the axial direction as viewed in the radial direction, and are arranged so as not to overlap each other as viewed in the radial direction.

In the case where the slide gear SG is moved to the side of the second rotating electrical machine (the left side in FIG. 10) in the axial direction on the shaft of the first gear RG1, and meshes with the fifth gear RG5, the slide gear SG is in an engaged state in which the rotor shaft RS2 of the second rotating electrical machine is drivingly coupled to the output shaft O.

On the other hand, in the case where the slide gear SG is moved to the side of the first rotating electrical machine (the right side in FIG. 10) in the axial direction on the shaft of the first gear RG1, and meshes with the fourth gear RG4, the slide gear SG is in an engaged state in which the rotor shaft RS1 of the first rotating electrical machine is drivingly coupled to the output shaft O.

In the case where the slide gear SG is located at an intermediate position between the fourth gear RG4 and the fifth gear RG5, the slide gear SG is in a disconnected state in which the slide gear SG does not mesh with any of the fourth gear RG4 and the fifth gear RG5, and the output shaft O is not drivingly coupled to any of the rotor shaft RS1 of the first rotating electrical machine and the rotor shaft RS2 of the second rotating electrical machine.

Thus, the slide gear SG functions as the first clutch CL1 that selectively drivingly couples the rotor shaft RS1 of the first rotating electrical machine to the output shaft O or disconnects the rotor shaft RS1 of the first rotating electrical machine from the output shaft O, and also functions as the second clutch CL2 that selectively drivingly couples the rotor shaft RS2 of the second rotating electrical machine to the output shaft O or disconnects the rotor shaft RS2 of the second rotating electrical machine from the output shaft O.

The slide gear SG may be configured to mesh with both the fourth gear RG4 and the fifth gear RG5 in the case where the fifth gear RG5 and the fourth gear RG4 are arranged at a smaller interval therebetween in the axial direction, and the slide gear SG is located at an intermediate position between the fourth gear RG4 and the fifth gear RG5. In this case, the slide gear SG is in an engaged state in which the output shaft O is drivingly coupled to both the rotor shaft RS1 of the first rotating electrical machine and the rotor shaft RS2 of the second rotating electrical machine. This configuration allows the torque of both the first rotating electrical machine MG1 and the second rotating electrical machine MG2 to be transmitted to the wheels to cause the vehicle to run.

<Control Device 30>

The dog clutch DG2 and the slide gear SG are configured to move in the axial direction by an electromagnetic force, a driving force of a servomotor, etc., and are controlled by the control device 30 by a method similar to that executed by the first clutch control unit 33 or the second clutch control unit 34.

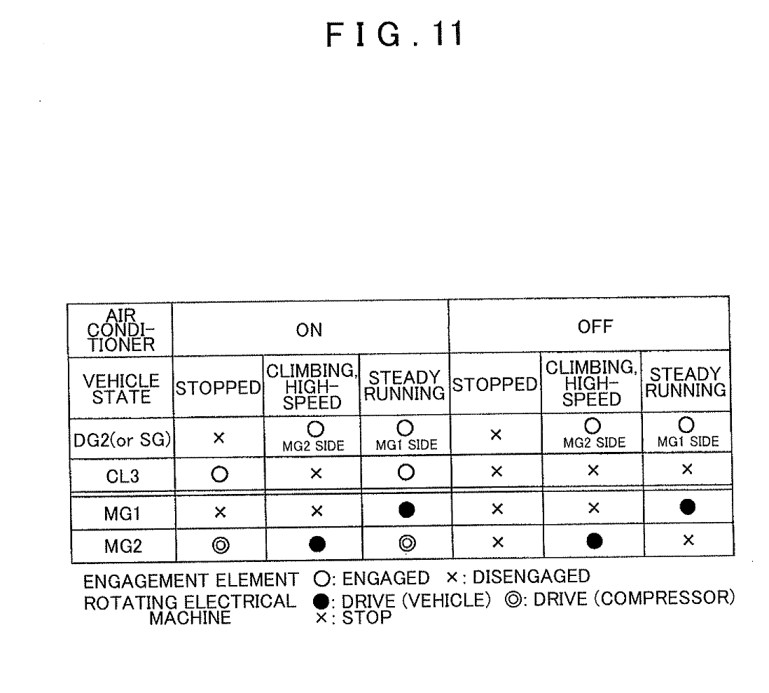

Specifically, as shown in FIG. 11, in the case where the running state of the vehicle is the “climbing” state or the “high-speed running” state, the integration control unit 36 controls the dog clutch DG2 or the slide gear SG to be engaged with the side of the second rotating electrical machine MG2, regardless of whether there is a request to operate the air conditioner or not, and thus drivingly couples the rotor shaft RS2 of the second rotating electrical machine to the output shaft O, so that the driving force of the second rotating electrical machine MG2 can be transmitted to the output shaft O.

In the case where the running state of the vehicle is the “steady running” state, the integration control unit 36 controls the dog clutch DG2 or the slide gear SG to be engaged with the side of the first rotating electrical machine MG1, regardless of whether there is a request to operate the air conditioner or not, and thus drivingly couples the rotor shaft RS1 of the first rotating electrical machine to the output shaft O, so that the driving force of the first rotating electrical machine MG1 can be transmitted to the output shaft O.

In the case where the running state of the vehicle is the “stopped” state, the integration control unit 36 controls the dog clutch DG2 or the slide gear SG to a disengaged state in which the output shaft O is not engaged with any of the rotor shaft RS1 of the first rotating electrical machine and the rotor shaft RS2 of the second rotating electrical machine, regardless of whether there is a request to operate the air conditioner or not.

<Compressor CM>

As described above, unlike the second clutch CL2, the dog clutch DG2 or slide gear SG provided instead of the second clutch CL2 is disposed on the shaft of the first gear RG1, and is not disposed on the rotor shaft RS2 of the second rotating electrical machine. Thus, as shown in FIGS. 9 and 10, the compressor CM and the third clutch CL3 can be disposed on the same side as that on which the fifth gear RG5 is disposed with respect to the second rotating electrical machine MG2. Thus, the compressor CM can be positioned to overlap the output differential gear unit DF as viewed in the radial direction, which allows the space located radially outside the output differential gear unit DF to be effectively used.

(4) The above embodiment is described with respect to an example in which the power transmission mechanism RG is a gear mechanism formed by a plurality of gears. However, embodiments of the present invention are not limited to this. That is, the power transmission mechanism RG may be any power transmission mechanism as long as it is a power transmission mechanism that drivingly couples the rotor shaft RS1 of the first rotating electrical machine or the rotor shaft RS2 of the second rotating electrical machine to the output shaft O at a predetermined speed ratio. For example, the power transmission mechanism RG may be a mechanism that is formed by a belt and a plurality of pulleys, or may be a mechanism that is formed by a chain and a plurality of gears.

(5) The above embodiment is described with respect to an example in which the first clutch CL1 and the third clutch CL3 are controlled to a disengaged state and driving of the first rotating electrical machine MG1 is stopped, in the case where there is either a request to operate the air conditioner or no request to operate the air conditioner, and the running state of the vehicle is the “climbing” state. However, embodiments of the present invention are not limited to this. That is, in the case where there is either a request to operate the air conditioner or no request to operate the air conditioner, and the running state of the vehicle is the “climbing” state, the integration control unit 36 may control the first clutch CL1 to an engaged state to also drivingly couple the rotor shaft RS1 of the first rotating electrical machine MG1 to the output shaft O, so that not only the driving force of the second rotating electrical machine MG2 but also the driving force of the first rotating electrical machine MG1 can be transmitted to the output shaft O. In this case, the integration control unit 36 calculates the first required torque and the second required torque based on the vehicle required torque. For example, the first required torque and the second required torque are set so that the sum of the first required torque and the second required torque, in conversion to the torque on the output shaft O, is equal to the vehicle required torque. At this time, if the rotational speed of the output shaft O overlaps the high efficiency region of the first rotating electrical machine MG1, the integration control unit 36 may preferentially set the first required torque according to the high efficiency region of the first rotating electrical machine MG1, and may set the second required torque to the torque calculated by subtracting the first required torque from the vehicle required torque.

In the case where there is a request to operate the air conditioner, the integration control unit 36 may control not only the first clutch CL1 but also the third clutch CL3 to an engaged state to drivingly couple the rotor shaft RS2 of the second rotating electrical machine MG2 to the compressor coupling shaft CMC, so that not only the driving force of the second rotating electrical machine MG2 but also the driving force of the first rotating electrical machine MG1 can be transmitted to the compressor CM. The integration control unit 36 calculates the first required torque and the second required torque based on the vehicle required torque and the compressor required torque. For example, the first required torque and the second required torque are set so that the sum of the first required torque and the second required torque in conversion to the output on the output shaft O is equal to the sum of the vehicle required torque and the compressor required torque in conversion to the output on the output shaft O. At this time, as described above, the first required torque may be preferentially set according to the high efficiency region of the first rotating electrical machine MG1.

(6) The above embodiment is described with respect to an example in which the third clutch CL3 is controlled to a disengaged state in the case where there is a request to operate the air conditioner, and the running state of the vehicle is the “high-speed running” state. However, embodiments of the present invention are not limited to this. That is, in the case where there is a request to operate the air conditioner, and the running state of the vehicle is the “high-speed running” state, the integration control unit 36 may control the third clutch CL3 to an engaged state. In this case, a variable displacement compressor capable of adjusting driving load (negative torque) may be used as the compressor CM. Control is performed to change the driving load (the negative torque) of the compressor so that the driving force of the second rotating electrical machine MG2 is preferentially used to drive the vehicle. For example, control is performed so that the driving load (the negative torque) of the compressor falls within the torque range calculated by subtracting the vehicle required torque from the output converted maximum torque of the second rotating electrical machine MG2 at the current rotational speed of the output shaft O. The second required torque is set to the sum of the vehicle required torque and the driving load (an absolute value of the negative torque) of the compressor.

(7) The above embodiment is described with respect to an example in which the compressor coupling shaft CMC is drivingly coupled to the rotor shaft RS2 of the second rotating electrical machine MG2 via the third clutch CL3. However, embodiments of the present invention are not limited to this. That is, the drive device 1 for electric vehicles may not include the third clutch CL3, and the compressor coupling shaft CMC may be directly drivingly coupled to the rotor shaft RS2 of the second rotating electrical machine MG2. In this case, a variable displacement compressor capable of adjusting driving load (negative torque) may be used as the compressor CM. Control is performed to change the driving load of the variable displacement compressor CM. For example, in the case where there is no request to operate the air conditioner, the driving load of the compressor CM is changed to zero. In the case where there is a request to operate the air conditioner, and the running state of the vehicle is the “stopped” state or the “steady” state, the driving load of the compressor CM is changed to driving load required by the compressor. In the case where there is a request to operate the air conditioner, and the running state of the vehicle is the “climbing” state or the “high-speed running” state, the driving load of the compressor CM is changed to zero. Note that even when the running state of the vehicle is the “climbing” state or the “high-speed running” state, the driving load of the compressor CM may be set to be larger than zero, as described in the other embodiments shown above.

(8) The above embodiment is described with respect to an example in which each of the first clutch CL1 and the second clutch CL2 as an engagement device is a clutch of the type whose engagement or disengagement can be controlled by the control device 30. However, embodiments of the present invention are not limited to this. That is, one or both of the first clutch CL1 and the second clutch CL2 may be a one-way clutch that transmits a rotational force only in one direction, and slips and does not transmit any rotational force in the opposite direction. That is, the one-way clutch is brought into in an engaged state when transmitting a driving force from the first rotating electrical machine MG1 or the second rotating electrical machine MG2 to the output shaft O, and otherwise, is brought into a disengaged state. This configuration can reduce the number of actuators to be controlled by the control device 30, and thus can simplify the system and reduce the cost.

(9) The above embodiment is described with respect to an example in which each of the first clutch CL1, the second clutch CL2, and the third clutch CL3 are a clutch that engages or disengages rotating members with or from each other. However, embodiments of the present invention are not limited to this. That is, the first clutch CL1, the second clutch CL2, or the third clutch CL3 may be a brake that engages or disengages a rotating member with or from a non-rotating member. For example, a planetary gear mechanism having three rotating elements may be provided between two rotating members to be drivingly coupled together or to be disconnected from each other, and one of the rotating elements may be engaged with or disengaged from the non-rotating member by the brake, and the other two rotating members may be drivingly coupled together or disconnected from each other.

The present invention can be used in a preferable manner in drive devices for electric vehicles, which include an output member drivingly coupled to wheels, and a compressor coupling member coupled to a compressor for an air conditioner, and which generates, by a rotating electrical machine, a driving force to be transmitted to the output member and the compressor coupling member.

What is claimed is:

1. A drive device for an electric vehicle, which includes an output member drivingly coupled to a wheel, and a compressor coupling member coupled to a compressor for an air conditioner, comprising:
a first rotating electrical machine having a rotor shaft drivingly coupled to the output member;
a second rotating electrical machine having a rotor shaft drivingly coupled to the compressor coupling member and drivingly coupled to the output member;
a first engagement device capable of disconnecting the drive coupling between the rotor shaft of the first rotating electrical machine and the output member; and
a second engagement device capable of disconnecting the drive coupling between the rotor shaft of the second rotating electrical machine and the output member.

2. The drive device for an electric vehicle according to claim 1, wherein
the driving force to be transmitted to the output member and the compressor coupling member is generated only by the first rotating electrical machine and the second rotating electrical machine.

3. The drive device for an electric vehicle according to claim 1, wherein
a maximum output that is set for the second rotating electrical machine is larger than a maximum output that is set for the first rotating electrical machine.

4. The drive device for an electric vehicle according to claim 1, wherein
an output converted maximum rotational speed of the second rotating electrical machine that is obtained by converting a maximum value of a rotational speed, at which the second rotating electrical machine can transmit torque to the output member, to a rotational speed at the output member is equal to or higher than a rotational speed of the output member at a maximum vehicle speed.

5. The drive device for an electric vehicle according to claim 1, wherein
an output converted maximum rotational speed of the first rotating electrical machine that is obtained by converting a maximum value of a rotational speed, at which the first rotating electrical machine can transmit torque to the output member, to a rotational speed at the output member is lower than that of the second rotating electrical machine.

6. The drive device for an electric vehicle according to claim 1, wherein
output converted maximum torque of the second rotating electrical machine, which is a maximum value of torque the second rotating electrical machine can transmit to the output member, is higher than that of the first rotating electrical machine, and the output converted maximum torque of the second rotating electrical machine is set so that the output converted maximum torque of the second rotating electrical machine is equal to or larger than maximum vehicle required torque that is required to be transmitted to the output member to drive the wheel, individually or in combination with the output converted maximum torque of the first rotating electrical machine.

7. The drive device for an electric vehicle according to claim 1, wherein
the first engagement device disconnects the drive coupling between the rotor shaft of the first rotating electrical machine and the output member at a predetermined vehicle speed or higher.

8. The drive device for an electric vehicle according to claim 1, further comprising:
a third engagement device capable of disconnecting the drive coupling between the rotor shaft of the second rotating electrical machine and the compressor coupling member.

9. The drive device for an electric vehicle according to claim 2, wherein
a maximum output that is set for the second rotating electrical machine is larger than a maximum output that is set for the first rotating electrical machine.

10. The drive device for an electric vehicle according to claim 9, wherein
an output converted maximum rotational speed of the second rotating electrical machine that is obtained by converting a maximum value of a rotational speed, at which the second rotating electrical machine can transmit torque to the output member, to a rotational speed at the output member is equal to or higher than a rotational speed of the output member at a maximum vehicle speed.

11. The drive device for an electric vehicle according to claim 10, wherein
an output converted maximum rotational speed of the first rotating electrical machine that is obtained by converting a maximum value of a rotational speed, at which the first rotating electrical machine can transmit torque to the output member, to a rotational speed at the output member is lower than that of the second rotating electrical machine.

12. The drive device for an electric vehicle according to claim 11, wherein
output converted maximum torque of the second rotating electrical machine, which is a maximum value of torque the second rotating electrical machine can transmit to the output member, is higher than that of the first rotating electrical machine, and the output converted maximum torque of the second rotating electrical machine is set so that the output converted maximum torque of the second rotating electrical machine is equal to or larger than maximum vehicle required torque that is required to be transmitted to the output member to drive the wheel, individually or in combination with the output converted maximum torque of the first rotating electrical machine.

13. The drive device for an electric vehicle according to claim 12, wherein
the first engagement device disconnects the drive coupling between the rotor shaft of the first rotating electrical machine and the output member at a predetermined vehicle speed or higher.

14. The drive device for an electric vehicle according to claim 13, further comprising:
a third engagement device capable of disconnecting the drive coupling between the rotor shaft of the second rotating electrical machine and the compressor coupling member.

15. The drive device for an electric vehicle according to claim 2, wherein
an output converted maximum rotational speed of the second rotating electrical machine that is obtained by converting a maximum value of a rotational speed, at which the second rotating electrical machine can transmit torque to the output member, to a rotational speed at the output member is equal to or higher than a rotational speed of the output member at a maximum vehicle speed.

16. The drive device for an electric vehicle according to claim 2, wherein
an output converted maximum rotational speed of the first rotating electrical machine that is obtained by converting a maximum value of a rotational speed, at which the first rotating electrical machine can transmit torque to the output member, to a rotational speed at the output member is lower than that of the second rotating electrical machine.

17. The drive device for an electric vehicle according to claim 2, wherein
output converted maximum torque of the second rotating electrical machine, which is a maximum value of torque the second rotating electrical machine can transmit to the output member, is higher than that of the first rotating electrical machine, and the output converted maximum torque of the second rotating electrical machine is set so that the output converted maximum torque of the second rotating electrical machine is equal to or larger than maximum vehicle required torque that is required to be transmitted to the output member to drive the wheel, individually or in combination with the output converted maximum torque of the first rotating electrical machine.

18. The drive device for an electric vehicle according to claim 3, wherein
an output converted maximum rotational speed of the second rotating electrical machine that is obtained by converting a maximum value of a rotational speed, at which the second rotating electrical machine can transmit torque to the output member, to a rotational speed at the output member is equal to or higher than a rotational speed of the output member at a maximum vehicle speed.

19. The drive device for an electric vehicle according to claim 3, wherein
an output converted maximum rotational speed of the first rotating electrical machine that is obtained by converting a maximum value of a rotational speed, at which the first rotating electrical machine can transmit torque to the output member, to a rotational speed at the output member is lower than that of the second rotating electrical machine.

20. The drive device for an electric vehicle according to claim 3, wherein
output converted maximum torque of the second rotating electrical machine, which is a maximum value of torque the second rotating electrical machine can transmit to the output member, is higher than that of the first rotating electrical machine, and the output converted maximum torque of the second rotating electrical machine is set so that the output converted maximum torque of the second rotating electrical machine is equal to or larger than maximum vehicle required torque that is required to be transmitted to the output member to drive the wheel, individually or in combination with the output converted maximum torque of the first rotating electrical machine.
